(19) United States
(12) Patent Application Publication
(10) Pub. No.: US 2017/0099847 A1
(43) Pub. Date: Apr. 13, 2017

(54) DEVICE FOR AND METHOD OF MAKING EDIBLE CONE-SHAPED CONTAINERS

(71) Applicant: Beljam's All Day Waffles Inc., Surrey (CA)

(72) Inventor: Nathen Shandler, Surrey (CA)

(21) Appl. No.: 15/087,031

(22) Filed: Mar. 31, 2016

(30) Foreign Application Priority Data
Oct. 9, 2015 (CA) 2907292

(51) Int. Cl. A21C 15/02; A21D 13/00; A47J 43/20

(52) U.S. Cl. CPC A21C 15/025; A47J 43/20; A21D 13/0029

(57) ABSTRACT

A device for making an edible cone-shaped container comprises a substantially conical body having a top and a bottom. The substantially conical body tapers from the bottom to the top thereof. There is a handle extending from the substantially conical body adjacent the bottom thereof.

### FIELD OF THE INVENTION

The present invention relates to a device for and a method of making edible cone-shaped containers and, in particular, to a cone-shaped device for making edible cone-shaped containers and a method of using the same.

### BACKGROUND OF THE INVENTION

U.S. Pat. No. 5,626,897, which issued to Goldstein on May 6, 1997, discloses forming an edible food container by wrapping an elongate flat strip of uncooked bread dough around a conically-shaped mandrel to form a plurality of spiral turns with an overlap between adjacent turns of the spiral. The resultant uncooked dough cone is then baked to form an edible, cone-shaped container of soft bread. The bread cone is removed from the mandrel and the hollow interior of the cone is filled with a selected filling.

U.S. Pat. No. 4,795,652, which issued to Cooper on Jan. 3, 1989, discloses a method of forming an edible food container from viscous dough. The method comprises the steps of mixing the dough, forming the dough into a generally continuous sheet, and cutting the sheet of dough into generally parallelogram shaped pieces of a predetermined length and width. Each of the dough pieces is wrapped around a shaping surface of a shaping mandrel so that the first and second ends of each dough piece engage each other to form a generally continuous covering of dough around the shaping mandrel. Excess dough extending beyond the ends of the shaping surface of the mandrel is trimmed away and the dough on the mandrel is showered with caustic soda. The dough is then baked and cooled on the mandrel. After cooling, the baked dough is twisted with respect to the mandrel to remove the edible food container from the mandrel. In the preferred embodiment, the shaping mandrel is cone shaped for forming a cone shaped edible food container.

### SUMMARY OF THE INVENTION

It is an object of the present invention to provide a device for making edible cone-shaped containers and a method of using the same.

There is accordingly provided a device for making an edible cone-shaped container, the device comprising a substantially conical body having a top and a bottom. The substantially conical body tapers from the bottom to the top thereof. There is a handle extending from the substantially conical body adjacent the bottom thereof.

The substantially conical body may have a truncated tip. The handle may be connected to the substantially conical body by a nut and a bolt. The substantially conical body may be formed from a sheet having opposite ends which are connected together. The ends of the sheet may be connected together by a plurality of rivets. The substantially conical body may have a hollow interior.

There is also provided a method of making an edible cone-shaped container, and a food product prepared in accordance with the method. The method comprises placing a flat, pliable food element on top of a foil sheet. A device having a substantially conical body is placed on top of the food element. A first end of the food element is wrapped around the substantially conical body of the device. A second end of the food element is wrapped around the substantially conical body of the device in the opposite direction to form an edible cone-shaped container. The foil sheet is wrapped around the edible cone-shaped container and a receptacle is placed over the foil sheet. The device with the edible cone-shaped container and the foil sheet wrapped around it is inverted such that the receptacle is supporting the edible cone-shaped container. The device is then removed from the edible cone-shaped container.

An internal recess of the edible cone-shaped container may be filled with edible fillings after removing the device. The foil sheet may be positioned diagonally relative to the food element. The device may be placed on top of the food element such that a tip of the device is spaced apart inwardly from an edge of the food element. The tip of the device may have a truncated tip and the truncated tip may create a flat bottom to the edible cone-shaped container as the ends of the food element are wrapped around the substantially conical body of the device. The device may be inverted using a handle which extends from the substantially conical body thereof. The food element may be a waffle. The edible fillings may include fruit, ice cream, meat and eggs.

### BRIEF DESCRIPTION OF THE DRAWINGS

The invention will be more readily understood from the following description of the embodiments thereof given, by way of example only, with reference to the accompanying drawings, in which:

FIG. 1 is a perspective view of a device for making edible cone-shaped containers;

FIG. 2 is another perspective view of the device of FIG. 1;

FIG. 3 is a bottom perspective view of the device of FIG. 1;

FIG. 4 is a perspective view showing the device of FIG. 1 placed on top of a waffle sheet which lies on top of a foil sheet;

FIG. 5 is a perspective view showing a first end of the waffle sheet wrapped around the device of FIG. 1;

FIG. 6 is a perspective view showing first and second ends of the waffle sheet wrapped around the device of FIG. 1;

FIG. 7 is a perspective view showing the foil sheet wrapped around the waffle sheet which in turn is wrapped around the device of FIG. 1;

FIG. 8 is a perspective view showing the device of FIG. 1 positioned upright with the waffle sheet and the foil sheet wrapped around it;

FIG. 9 is a perspective view showing a substantially conical receptacle placed over the foil sheet which is wrapped around the waffle sheet and the device of FIG. 1;

FIG. 10 is a perspective view showing an edible cone-shaped container made with the device of FIG. 1; and

FIG. 11 is a perspective view of another device for making edible cone-shaped containers.

### DESCRIPTION OF SPECIFIC EMBODIMENTS

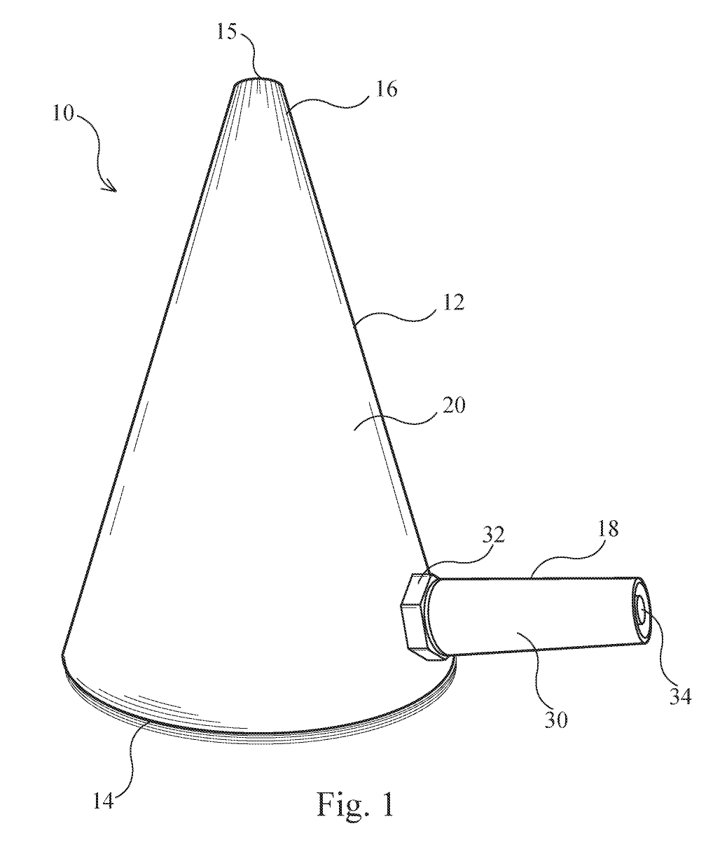

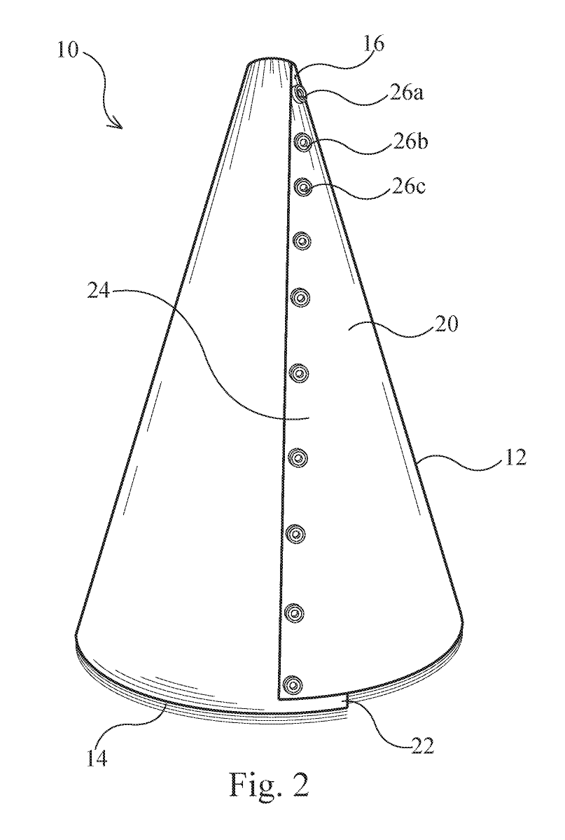

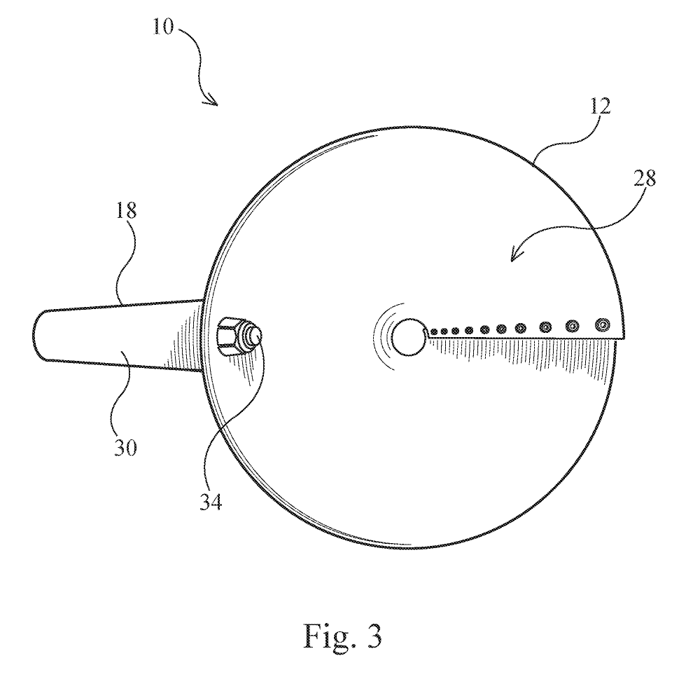

Referring to the drawings and first to FIG. 1, there is shown a device 10 for making edible cone-shaped containers. The device 10 has a body 12 with a substantially frustoconical outer surface in this example. However, in other examples, the body 12 may have a substantially conical outer surface. The body 12 is tapered from a bottom 14 to a top 16 thereof and terminates in a truncated tip 15. There is a handle 18 connected to the body 12 near the bottom 14 thereof. The body 12 is formed of a sheet 20 of a suitable pliable material such as sheet metal or plastic sheet. The sheet 20 has lateral ends 22 and 24, shown in FIG. 2, which are brought together to form the substantially frustoconical outer surface of the body 12. The lateral end 24 overlaps the lateral end 22 and is affixed to the lateral end 22 by fasteners which in this example are a plurality of rivets, for example, rivets 26a, 26b and 26c. The body 12 accordingly has a hollow interior 28 as shown in FIG. 3. However, in other examples, the conical body may have a solid interior. The handle 18 in this example includes a generally cylindrical body 30, shown in FIG. 1, which is connected to the body 12 by a nut 32 and a bolt 34, best shown in FIG. 3.

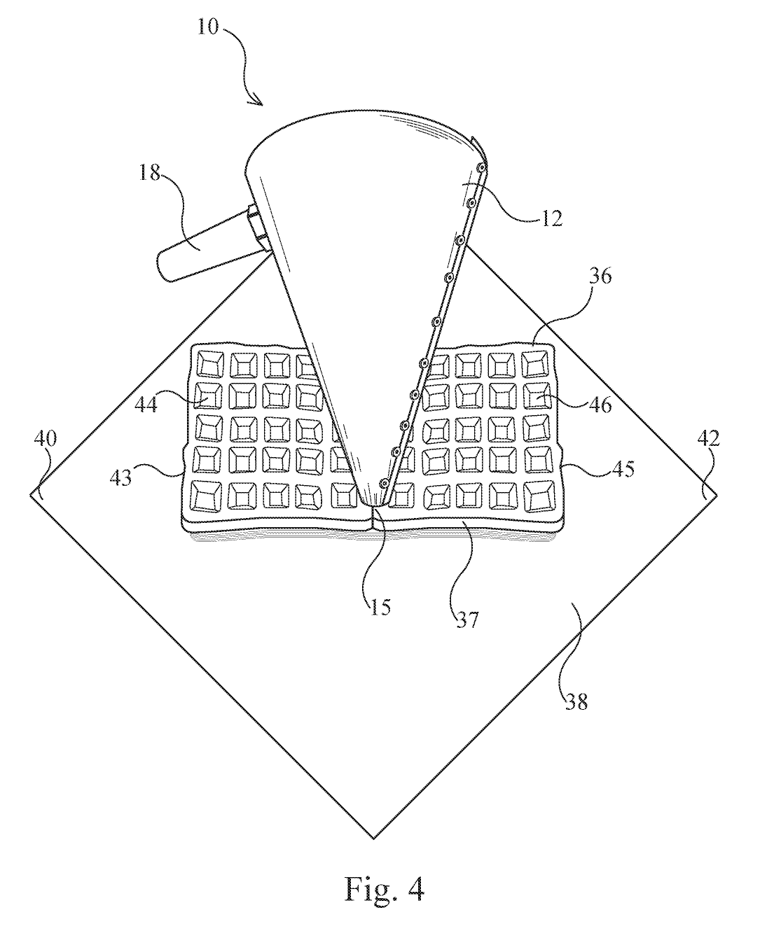

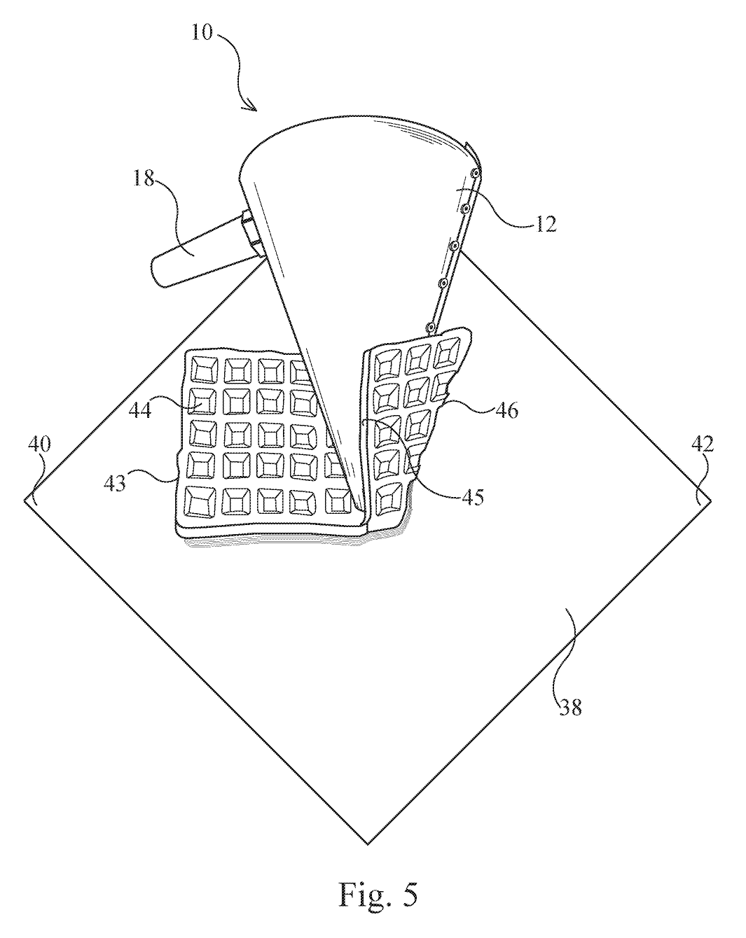

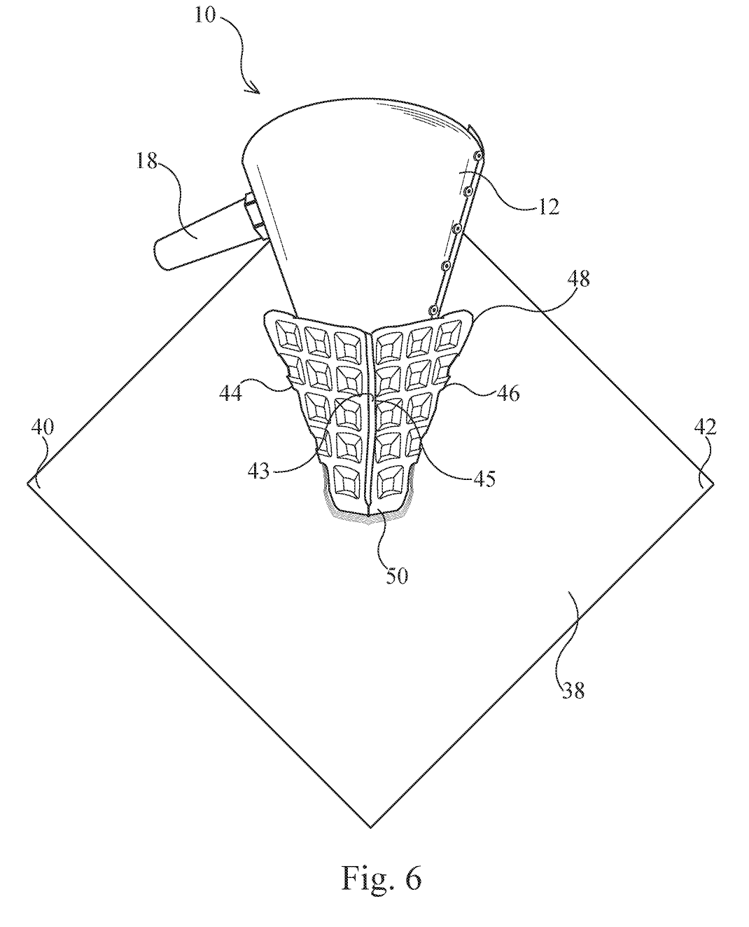

Referring now to FIG. 4, the device 10 is placed on top of an edible waffle sheet 36 which lies on top of a foil sheet 38. The foil sheet 38 is generally quadrilateral in shape and is positioned diagonally relative to the waffle sheet 36. In particular, the waffle sheet 36 is placed on top of the foil sheet 38 such that the waffle sheet is generally disposed between opposite corners 40 and 42 of the foil sheet. The device 10 is placed on top of the waffle sheet 36 such that the truncated tip 15 of the body 12 is spaced apart inwardly from an edge 37 of the waffle sheet. The waffle sheet 36 consists of two adjacently conjoined waffles 44 and 46 which are generally quadrilateral in shape. The waffles 44 and 46 are conventional edible waffles and therefore are not described in detail herein. One of the waffles 46 is wrapped around the body 12 of the device 10 as shown in FIG. 5. The other waffle 44 is then wrapped around the body 12 of the device 10 in the opposite direction as shown in FIG. 6. An end 43 of the waffle 44 overlaps an end 45 of the waffle 46 to form an edible cone-shaped container 48. The truncated tip 15 causes a flat bottom 50 of the edible cone-shaped container 48 to be created as the waffles 44 and 46 are wrapped around the body 12. In one example, the waffles 44 and 46 may be freshly made waffles which are more appetizing to consumers. Furthermore, freshly made waffles are more pliable and thus easier to wrap around the body 12 of the device 10. This reduces potential breakage of the waffles during wrapping and results in a more uniformly shaped cone which is more visually appealing to consumers.

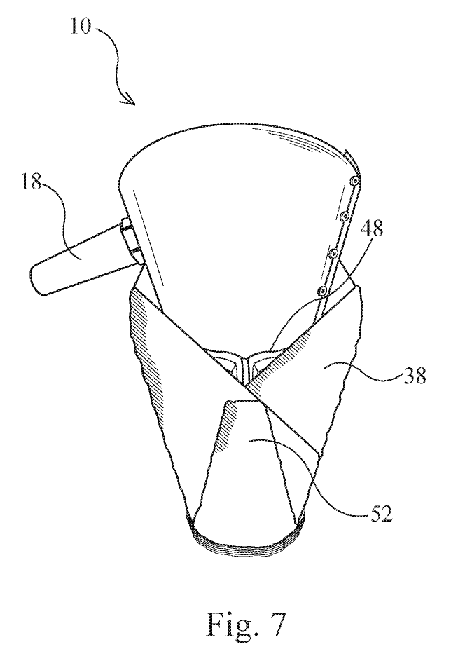

The foil sheet 38 is wrapped around the edible cone-shaped container 48 as shown in FIG. 7. In particular, the corners 40 and 42 of the foil sheet 38, shown in FIG. 6, are folded towards each other. A resulting tail portion 52 is then folded over top as best shown in FIG. 7. The handle 18 inhibits rolling of the device 10 from side to side as the waffle sheet 36 and the foil sheet 38 are wrapped around the device.

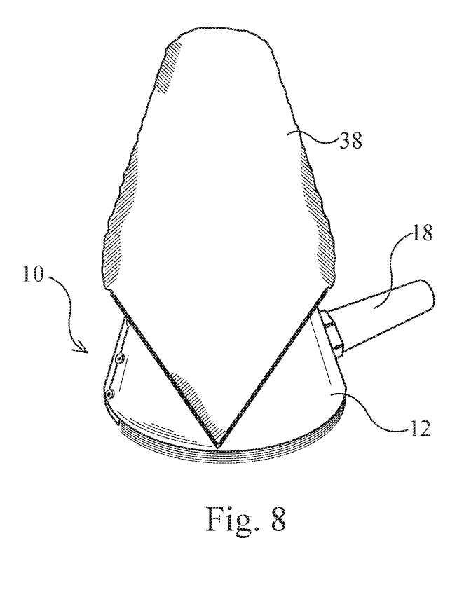

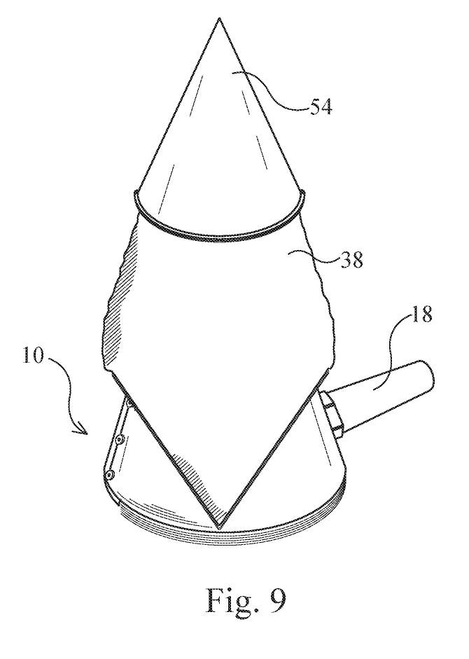

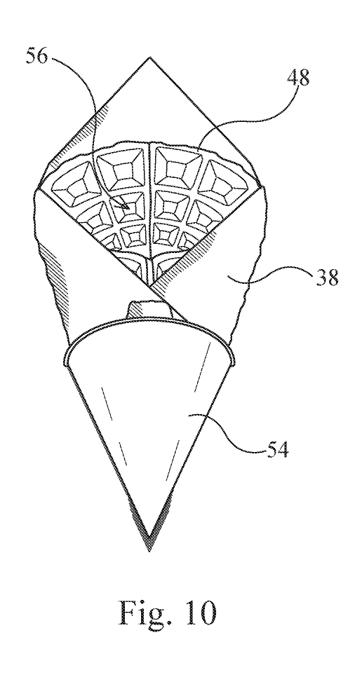

The device 10, with the edible cone-shaped container 48 and the foil sheet 38 wrapped around it, is then positioned upright using the handle 18 as shown in FIG. 8. A substantially conical receptacle 54 is then placed over the foil sheet 38 as shown in FIG. 9. Holding onto the substantially conical receptacle 54 with one hand and the handle 18 with the other hand, the device 10 is flipped upside down so that the substantially conical receptacle is supporting the edible cone-shaped container 48. The device is then removed from the edible cone-shaped container 48 as shown in FIG. 10. The foil sheet 38 and the substantially conical receptacle 54 help retain the conical shape of the edible cone-shaped container 48 after the device 10 is removed. The edible cone-shaped container 48 has an internal recess 56 for receiving edible fillings such as fruit, ice cream, meat or eggs. The flat bottom 50, shown in FIG. 6, inhibits fillings from falling out of or leaking through the bottom of the edible cone-shaped container 48. This allows the filled edible cone-shaped container 48 to be easily carried and consumed by hand. The resulting creation is thus a fresh, ready-to-eat food product which serves as a convenient and appetizing alternative to prepackaged food products.

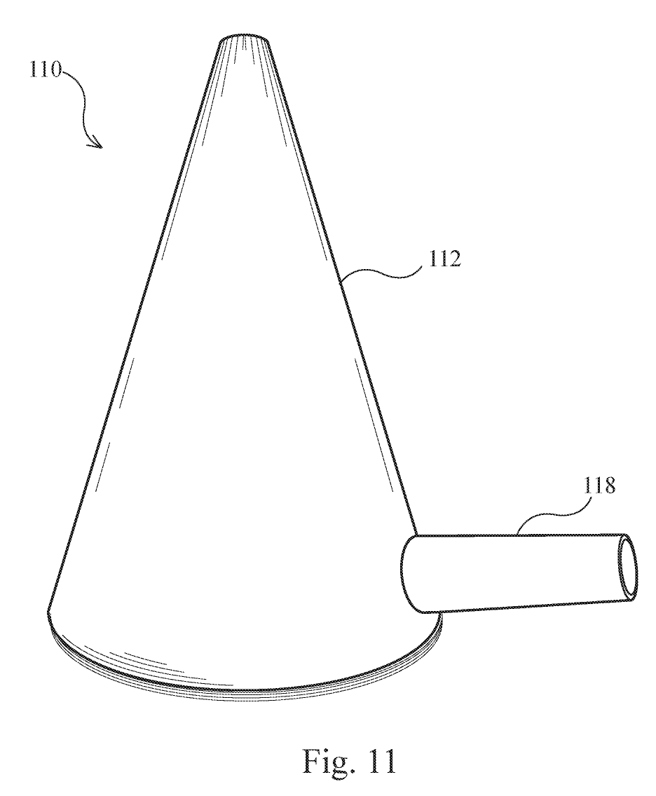

Referring now to FIG. 11, there is shown another device 110 for making edible cone-shaped containers. The device 110 is generally similar to the device 10 shown in FIGS. 1 to 9 with the exception that the device 110 includes a body 112 with a substantially frustoconical outer surface and a handle 118 extending from the body. The body 112 and the handle 118 are unitarily constructed and may be injection moulded.

It will be understood by a person skilled in the art that the device disclosed herein is described as making edible cone-shaped containers formed from waffles by way of example only. The device may be used to make edible cone-shaped containers formed from other pliable foods such as pancakes, crepes or tortillas.

It will be further understood by a person skilled in the art that many of the details provided above are by way of example only, and are not intended to limit the scope of the invention which is to be determined with reference to the following claims.

What is claimed is:

1. A device for making an edible cone-shaped container, the device comprising:
a substantially conical body having a top and a bottom, the substantially conical body tapering from the bottom to the top thereof; and
a handle extending from the substantially conical body adjacent the bottom thereof.

2. The device as claimed in claim 1, wherein the substantially conical body has a truncated tip.

3. The device as claimed in claim 1, wherein the handle is connected to the substantially conical body by a nut and a bolt.

4. The device as claimed in claim 1, wherein the substantially conical body is formed from a sheet having opposite ends which are connected together.

5. The device as claimed in claim 4, wherein the ends of the sheet are connected together by a plurality of rivets.

6. The device as claimed in claim 1, wherein the substantially conical body has a hollow interior.

7. A method of making an edible cone-shaped container, the method comprising:
placing a flat, pliable food element on top of a foil sheet;
placing a device having a substantially conical body on top of the food element;
wrapping a first end of the food element around the substantially conical body of the device;
wrapping a second end of the food element around the substantially conical body of the device in the opposite direction to form an edible cone-shaped container;
wrapping the foil sheet around the edible cone-shaped container;
placing a receptacle over the foil sheet;
inverting the device with the edible cone-shaped container and the foil sheet wrapped around it such that the receptacle is supporting the edible cone-shaped container; and
removing the device from the edible cone-shaped container.

8. The method as claimed in claim 7, wherein the foil sheet is positioned diagonally relative to the food element.

9. The method as claimed in claim 7, wherein the device is placed on top of the food element such that a tip of the device is spaced apart inwardly from an edge of the food element.

10. The method as claimed in claim 9, wherein the tip of the device is a truncated tip and wherein the truncated tip creates a flat bottom to the edible cone-shaped container as the ends of the food element are wrapped around the substantially conical body of the device.

11. The method as claimed in claim 7, wherein the device is inverted using a handle extending from the substantially conical body thereof.

12. The method as claimed in claim 7, wherein the food element is a waffle.

13. The method as claimed in claim 7, further including filling an internal recess of the edible cone-shaped container with edible fillings after removing the device.

14. The method as claimed in claim 13, wherein the edible fillings include fruit.

15. The method as claimed in claim 13, wherein the edible fillings include ice cream.

16. The method as claimed in claim 13, wherein the edible fillings include meat.

17. The method as claimed in claim 13, wherein the edible fillings include eggs.

18. A food product prepared by a method comprising the steps of:
placing a flat, pliable food element on top of a foil sheet;
placing a device having a substantially conical body on top of the food element;
wrapping a first end of the food element around the substantially conical body of the device;
wrapping a second end of the food element around the substantially conical body of the device in the opposite direction to form an edible cone-shaped container;
wrapping the foil sheet around the edible cone-shaped container;
placing a receptacle over the foil sheet;
inverting the device with the edible cone-shaped container and the foil sheet wrapped around it such that the receptacle is supporting the edible cone-shaped container;
removing the device from the edible cone-shaped container; and
filling an internal recess of the edible cone-shaped container with edible fillings after removing the device.
